(19) United States
(12) Patent Application Publication
(10) Pub. No.: US 2009/0028021 A1
(43) Pub. Date: Jan. 29, 2009

(54) Radial To Focus Cross Talk Cancellation In Optical Storage Systems

(75) Inventors: Bin Yin, Eindhoven (NL); Sjoerd Stallinga, Eindhoven (NL); Juil Lee, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,759

(22) PCT Filed: May 20, 2005
(86) PCT No.: PCT/IB2005/051650

§ 371 Date: Oct. 6, 2008

(30) Foreign Application Priority Data
Jun. 1, 2004 (EP) 04102440.7

(51) Int. Cl. G11B 20/18

(52) U.S. Cl. 369/53.17; G9B/20.046

(57) ABSTRACT

A signal processing technique is proposed for compensating for radial to focus crosstalk in an optical storage system including an astigmatic lens (25) and four-quadrant photodetector (26) for generating a focus error signal. A signal processor generates the focus error signal (FES_{RVO}), a tracking error signal (TES) and a central aperture signal (CA) and the proposed radial and focus crosstalk scheme can be described by the following equation (I): Where IFES_{RVO} represents the improved focus error signal and y¹ⱼ and y²ⱼ are vector components for scaling. Instead, scalar adaptive scaling factors γ₁ and γ₂ may be applied which can be updated by minimising a cost function J(y₁, y₂), which is able to imply the radial to focus crosstalk components remaining in the focus error signal.

This invention relates to a method and apparatus for radial to focus cross talk cancellation in optical storage systems, and to an optical storage system in which such method and apparatus are employed.

Radial to focus crosstalk is a persistent problem in the type of optical storage system in which an astigmatic lens is used to generate the focus error signal (FES) via a four-quadrant photo detector. In the presence of light imperfections, such as forward path 45° astigmatism and tangential beamlanding, the tracking signal will leak into the focussing channel, thereby creating radial to focus crosstalk. In some cases, for example, when a jump occurs, the laser spot can traverse a number of tracks in a short time, resulting in a high frequency tracking error signal (TES). This high frequency signal feeds through in the focussing control loop resulting in a focussing error offset. In response to this offset, the actuator moves the objective lens towards and/or away from the optical information carrier, causing an undesired oscillation within the focus servo system.

Various normalization methods have been designed to cancel the effect of diagonal beamlanding i.e. a displacement of the spot with respect to the detector in both the radial and tangential direction. They also have the effect of suppressing radial to focus crosstalk. The gist of the different normalization is that a correction signal is subtracted from the original focus error signal (FES). The method in U.S. Pat. No. 4,661,944, as an example, can be expressed as

$$\begin{matrix}{FES}_{NORM} = \frac{1}{2} [ \frac{Q 1 - Q 4}{Q 1 + Q 4} - \frac{Q 2 - Q 3}{Q 2 + Q 3} ] \\ = \frac{1}{1 - {TPP}^{2} / {CA}_{2}} [ \frac{FES}{CA} - \frac{TPP}{CA} \frac{TES}{CA} ]\end{matrix} \qquad ( 1 )$$

Where TPP=Q1+Q4−Q2−Q3 is a so-called tangential push-pull signal, FES Q1+Q3−Q2−Q4 is the non-normalised focus error signal, CA=Q1+Q2+Q3+Q4 is the total or central aperture signal, and TES=Q1+Q2−Q3−Q4 is called the (non-normalised) tracking error signal, or radial push-pull signal, and where Q1 to Q4 are the signals derived from the four quadrants of the photo-detector. Here the correction signal is proportional to the product of TPP and TES. In U.S. Pat. No. 5,850,081, it is proposed to subtract from FES the product of TPP and TES multiplied by a constant k, which has been predetermined. By doing so it is intended to reduce the radial to focus crosstalk caused by tangential beamlanding. The cross talk may be suppressed optically as well. Rotating the astigmatic servo lens around the optical axis and axial displacement of the photo detector are two possibilities. They can be used to tackle the radial to focus crosstalk due to forward light path astigmatism at 45 degrees. Their disadvantages lie in the difficulty of calibrating and influence on other signals.

The common weak point of these methods is that they are mostly designed to fight one type of imperfection and fixed during drive manufacturing, and therefore display a lack of robustness against varying working situations.

Thus, it is an object of the present invention to provide a method and apparatus for adaptively compensating for radial to focus crosstalk in an optical storage system, and to provide an optical storage system employing such a method and apparatus.

In accordance with the present invention, there is provided apparatus for compensating for radial to focus crosstalk in an optical storage system comprising an optical scanning spot for scanning an optical information carrier, an optical system for receiving radiation reflected from said optical information carrier and means for deriving from said reflected radiation a central aperture signal, a focus error signal and a tracking error signal, the apparatus comprising signal processing means for generating an improved focus error signal by subtracting from said focus error signal at least one signal consisting of a product of said tracking error signal or said central aperture signal and a scaling factor, said scaling factor being adaptive based on said improved focus error signal.

Also in accordance with the present invention, there is provided a method for compensating for radial to focus crosstalk in an optical storage system comprising an optical scanning spot for scanning an optical information carrier, an optical system for receiving radiation reflected from said optical information carrier and means for deriving from said reflected radiation a central aperture signal, a focus error signal and a tracking error signal, the method comprising providing signal processing means for generating an improved focus error signal by subtracting from said focus error signal at least one signal consisting of a product of said tracking error signal or said central aperture signal and a scaling factor, and updating said scaling factor adaptively based on said improved focus error signal.

Still further in accordance with the present invention, there is provided an optical storage system comprising an optical scanning spot for scanning an optical information carrier, an optical system for receiving radiation reflected from said optical information carrier and signal processing means for deriving from said reflected radiation a central aperture signal, a focus error signal and a tracking error signal, generating an improved focus error signal by subtracting from said focus error signal at least one signal consisting of a product of said tracking error signal or said central aperture signal and a scaling factor, and updating said scaling factor adaptively based on said improved focus error signal.

In a preferred embodiment, the improved focus error signal is generated by subtracting first and second signals from said focus error signal, said first signal consisting of a product of said tracking error signal and a first adaptive scaling factor and said second signal consisting of a product of said central aperture signal and a second scaling factor.

The first and second scaling factors are preferably different from each other. The scaling factors are preferably derived and updated by minimising a cost function which is able to imply the radial to focus crosstalk components remaining in said improved focus error signal. Such a cost function may be defined as the sum of the cross-correlation between a pre-processed improved focus error signal and the tracking error signal and that between a pre-processed improved focus error signal and the central aperture signal. The first scaling factor may then be directly proportional to an integral of the product of said pre-processed improved focus error signal and the tracking error signal and the second scaling factor may be directly proportional to an integral of said improved focus error signal and said central aperture signal. These integrals may be multiplied by a constant which controls the stability and speed of adaption of said scaling factors. It will be appreciated that the cost function defined above refers to the “pre-processed” improved focus error signal, in the context that “pre-processing” is used to remove the dependency of the focus error signal on the radial to focus crosstalk caused by the feedback mechanism of the focusing servo loop.

These and other aspects of the present invention will be apparent from, and elucidated with reference to, the embodiment described herein.

An embodiment of the present invention will now be described by way of example only and with reference to the accompanying drawings, in which:

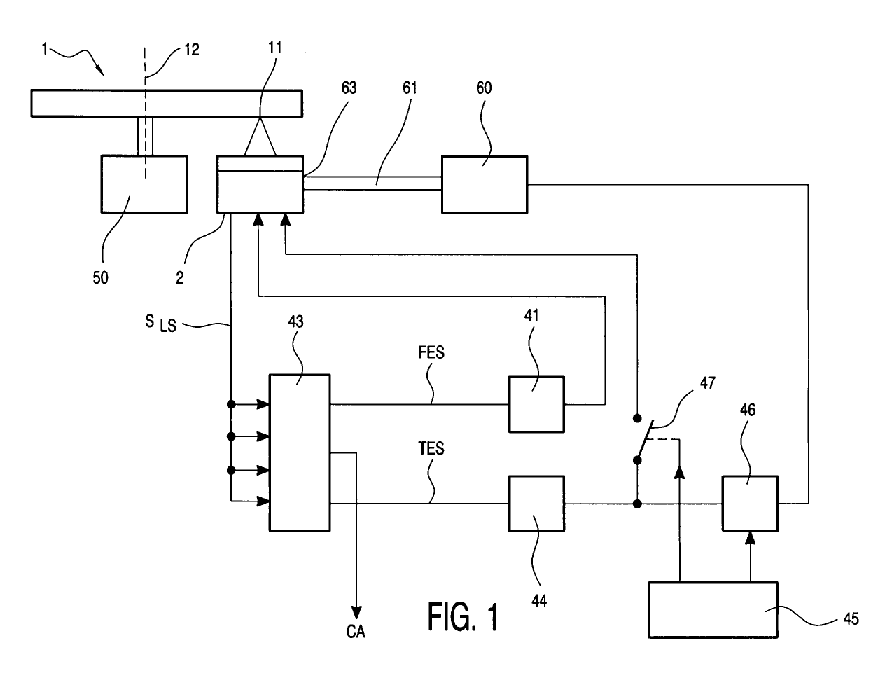

FIG. 1 is a schematic simplified block diagram illustrating an optical storage system according to an exemplary embodiment of the present invention;

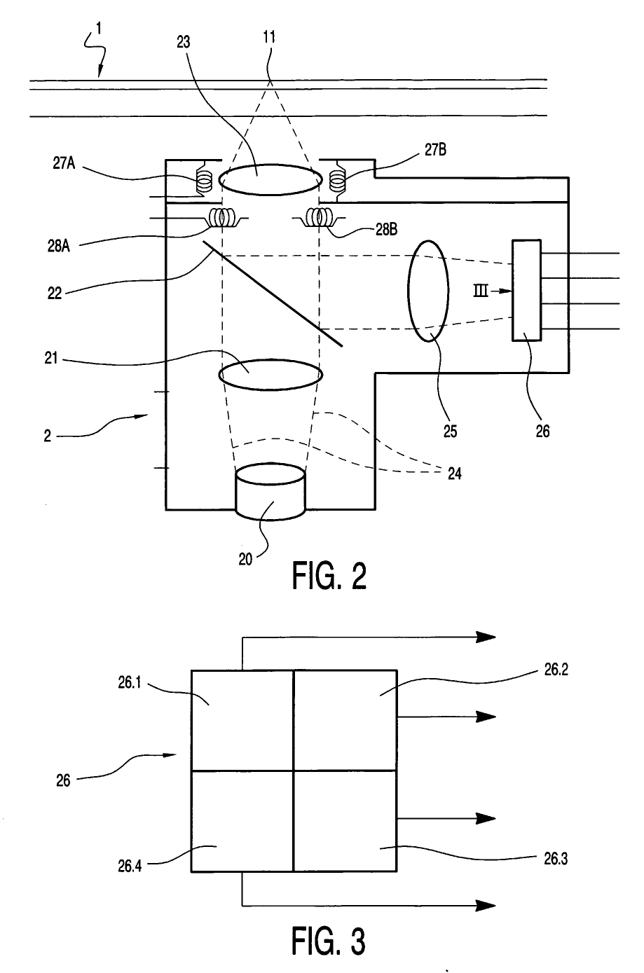

FIG. 2 illustrates schematically a part of the system of FIG. 1;

FIG. 3 shows a detail at location III in FIG. 2; and

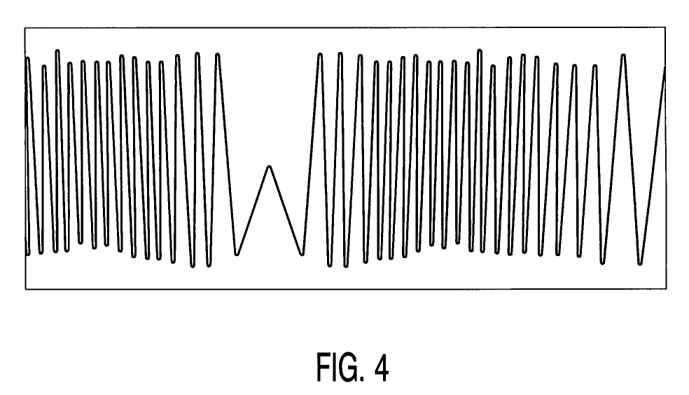

FIG. 4 illustrates a tracking error signal in an optical storage system when the scanning spot traverses tracks in the radial direction.

FIG. 1 shows a device for reading and/or writing information from/onto an optical information carrier 1. In the present embodiment, the information carrier is disc-shaped and has mutually concentric tracks around a centre which substantially coincides with an axis 12. Together, the tracks may form a spiral, although alternatively they may be separate from one another and closed in themselves. The device of FIG. 1 includes a reading device 2, which is illustrated in greater detail in FIG. 2 of the drawings.

Referring to FIG. 2, the reading device includes imaging means, namely a lens 21, a beam splitter 22 and a focussing element 23 for focussing a radiation beam 24 to a scanning spot 11 by means of which the information carrier 1 is scanned. The radiation beam is generated by a radiation source 20, such as a semi-conductor laser.

The reading device further includes detection means 25, 26 for generating a read signal S_{LS} which is indicative of the intensity of the radiation reflected from the information carrier 1 at the location of the scanning spot 11. In the present case, the detection means are provided by an astigmatic element 25 and a four-quadrant detector 26, which is shown in more detail in FIG. 3.

Referring to FIG. 3 of the drawings, the detector 26 supplies a read signal S_{LS} composed of the signals Q1, Q2, Q3, Q4 which are measures of the intensity of the radiation incident on each of the four quadrants 26.1, 26.2, 26.3 and 26.4 of the detector 26.

The device shown has an information transfer mode, in which the scanning spot 11 is moved along the tracks. The movement of the scanning spot 11 then has a tangential first direction with respect to the axis 12 of the information carrier 1. For this purpose, the information carrier 1 is rotated about the axis 12 by means of a motor 50.

The device also has a displacement mode, in which the scanning spot 11 is moved in a radial second direction transverse to the first direction. For this purpose, the device has coarse positioning means 60, in the form of a slide motor for moving a slide 61 which carries the reading device.

The device also has control means for controlling the imaging means 23 in response to a measurement signal FES (Focus Error Signal). The measurement signal FES is indicative of the degree of focussing of the radiation beam 24 at the location of the scanning spot 11. The Focus Error Signal (or a signal derived therefrom) serves as an input signal for a PID controller 41, which controls an actuator 27A, 27B for focussing the radiation beam 24.

The measurement signal FES is derived from the four signals Q1-Q4 by means of a signal processing unit 43, in such a manner that

FES=Q1+Q3−Q2−Q4

Furthermore, the signal processing unit 43 is responsive to the signals Q1Q4 to generate a radial push-pull signal TES (Tracking Error Signal), which is derived by:

TES=Q1+Q2−Q3−Q4

The tracking error signal TES serves as an input signal for a first radial servo system 44 for tracking in the information transfer mode. In this mode, the switch 47 is closed, as a result of which the first radial servo system 44 supplies a radial control signal to the radial actuators 28A, 28B. The radial control signal also serves as an input signal for a second radial servo system 46, which supplies the control signal for the slide motor 60. The switch 47 and the second radial servo system 46 are controlled by a microprocessor 45.

The signal processing unit further generates an information signal CA (Central Aperture) which is representative of the information patterns recorded on the information carrier. The information signal CA complies with:

CA=Q1+Q2+Q3+Q4

Thus, in summary, the optical storage system described above employs an astigmatic lens to generate a focus error signal (FES) via a four-quadrant photo detector 26. With the same detector, a radial push-pull signal (TES) for tracking and a central aperture signal (CA) for readout are also detected. The acquisition of these signals is summarised and illustrated in FIG. 3, where Qi (i=1-4) in formulae represents the integral of light intensity over the quadrant i.

Radial to focus crosstalk is a persistent problem in the type of optical storage system described above, in which an astigmatic lens is used to generate the focus error signal via a four-quadrant photo detector. In the presence of light imperfections, such as forward path 45° astigmatism and tangential beamlanding, the tracking signal will leak into the focussing channel, thereby creating radial to focus crosstalk. In some cases, for example, when a jump occurs, the laser spot can traverse a number of tracks in a short time, resulting in a high frequency tracking error signal, as shown in FIG. 4 of the drawings. This high frequency signal feeds through in the focusing control loop resulting in a focussing error offset. In response to this offset, the actuator moves the objective lens towards and/or away from the optical information carrier, causing an undesired oscillation within the focus servo system.

The present invention proposes a signal processing method for solving the radial to focus crosstalk problem explained above, which method is economic, adaptive and therefore robust, and able to deal with both tangential beamlanding and 45° forward path astigmatism.

Consider the following working example:

To the first order, the radial push-pull signal has the form of

TES=K₀(q)η sin ψ sin φ (2)

K₀ (q) is a constant factor determined by q=λ/(NA p), in which λ is the wavelength of the laser, NA the numerical aperture and p the pitch of the grating in radial direction. The complex diffraction amplitude of the grating is η exp (i ψ), and the additional phase due to the radial position x of the scanning spot is given by φ=2πx/p. Correspondingly, the DC of the central aperture signal varies as

CA=K₁(q)η cos ψ cos φ (3)

K₁ (q) is a constant determined by q. With an open focusing servo loop, the focusing error signal can be formulated as follows:

FES_{RVO}=FES+ε₁K₂(q)η sin ψ sin φ+A₂₋₂^{f}K₃(q)η sin ψ cos φ (4)

where FES_{RVO} and FES denote the focus error signals with and without cross talk, respectively. On the right hand of the equality, the second term represents the radial to focus crosstalk introduced by an amount of tangential beamlanding ε₁ (relative to the spot radius at the photo detector), while the third term represents the radial to focus crosstalk introduced by 45° forward path astigmatism with A₂₋₂^{f} indicating its strength. K₂ and K₃ are again constants determined by q.

The proposed radial to focus crosstalk cancelling scheme of this exemplary embodiment of the invention can be described by the following equation:

$${IFES}_{RVO} ( k ) = {FES}_{RVO} ( k ) - {\sum }_{j = 0}^{\overline{N 1 - 1}} {γ}_{j}^{1} ( k ) TES ( k - j ) - {\sum }_{j = 0}^{\overline{N 1 - 1}} {γ}_{j}^{2} ( k ) \overline{CA} ( k - j ) \qquad ( 5 )$$

IFES_{RVO} represents the improved focusing error signal. In the above equation, the scaling factors for TES and CA can be scalars or vectors. In the case that the scaling factors are vectors, the above formula with summing over j from j=0 to (N₁1) is applied, γ¹ⱼ and γ²ⱼ being vector components, and j, k, and N₁ being integers. In the case that the scaling factors are scalars, in the above formula the defined sums for γ¹ⱼ and γ²ⱼ are to be replaced by scalar scaling factors γ₁ and γ₂, and IFES_{RVO} (k), FES_{RVO} (k), TES(k-j) and CA(k-j) by IFES_{RVO}, FES_{RVO}, TES and CA, respectively. In the above more general formula, C̅A̅ is a high pass filtered version of CA, high pass filtering being applied to remove its DC component, both for adaption and cancellation. The adaptive scaling factors γ₁ and γ₂ are updated by minimizing a cost function J (γ₁, γ₂), which is able to imply the radial to focus crosstalk components remaining in the focus error signal. As an example, it can be defined as the cross-correlation between I̅F̅E̅S̅_{RVO} and TES and that between I̅F̅E̅S̅_{RVO} and CA:

J(γ₁, γ₂)=(E{ I̅F̅E̅S̅_{RVO} TES})²+(E{ I̅F̅E̅S̅_{RVO} CA})² (6)

Where I̅F̅E̅S̅_{RVO} comes from IFES_{RVO} pre-processed by a filter that is determined by the focusing servo loop dynamics and used to remove the dependency of FES on crosstalk components when the loop is closed.

If the cancellation is done in analog domain, the factors γ₁ and γ₂ will be adapted according to

$$\begin{matrix}{γ}_{1} = {μ}_{1} \frac{\partial J ( {γ}_{1} , {γ}_{2} )}{\partial {γ}_{1}} \approx 2 {μ}_{1} \int {\overline{IFES}}_{RVO} TES d t & ( 7 ) \\ {γ}_{2} = {μ}_{2} \frac{\partial J ( {γ}_{1} , {γ}_{2} )}{\partial {γ}_{2}} \approx 2 {μ}_{2} \int {\overline{IFES}}_{RVO} CA d t & \end{matrix}$$

where the arithmetic expectation E{ } is replaced with an integral. μ₁ and μ₂ are constants that control the stability and speed of the adaption. In digital domain, γ₁ and γ₂ can be updated in the sense of LMS as follows:

γ₁(k+1)=γ₁(k)+2μ₃└ I̅F̅E̅S̅_{RVO} TES┘(k), (8)

γ₂(k+1)=γ₂(k)+2μ₄└ I̅F̅E̅S̅_{RVO} CA┘(k),

where μ₃ and μ₄ are two constants controlling the stepsize of the update. From (2)˜(3), one can readily obtain that ideally γ₁ and γ₂ will converge to the optima

$${γ}_{1}^{*} = {ɛ}_{1} \frac{{K}_{2} ( q )}{{K}_{0} ( q )} , {γ}_{2}^{*} = {A}_{2 - 2}^{f} \frac{{K}_{3} ( q )}{{K}_{1} ( q )} tan ψ \qquad ( 9 )$$

In an alternative embodiment, the cost function is defined as the cross-correlation between IFES_{RVO} and T̅E̅S̅ and between IFES_{RVO} and C̅A̅:

J(γ₁, γ₂)=(E{IFES_{RVO} T̅E̅S̅})²+(E{IFES_{RVO} C̅A̅})² (10)

In the above formula, T̅E̅S̅ and C̅A̅ are pre-processed versions of TES and C̅A̅, respectively, through filtering fully taking into account the influence of the focusing servo loop on the said radial to focus crosstalk. Such pre-processing is hence determined to be the inverse of the focusing servo loop dynamics which is equivalent to a so-called sensitivity function.

In the above embodiment, the update in the digital domain is as follows:

γ₁(k+1)=γ₁(k)+2μ₃└IFES_{RVO} T̅E̅S̅┘(k) (11)

γ₂(k+1)=γ₂(k)+2μ₄ └IFES_{RVO} C̅A̅┘(k)

At those values the radial to focus crosstalk will be removed from the focus servo loop. In reality, the working condition of a drive normally varies from time to time, leading to, for example, different amounts of beamlanding. The proposed method can adaptively compensate for the resulting radial to focus crosstalk, and thus make the system more robust.

The present invention is particularly suited for all types of optical storage systems, including Blu-ray Disc (BD), Portable Blue (PB) systems, DVD+RW/R, DVD-ROM and CD+R/RW.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, do not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. Apparatus for compensating for radial to focus crosstalk in an optical storage system comprising an optical scanning spot (11) for scanning an optical information carrier (1), an optical system (25, 26) for receiving radiation reflected from said optical information carrier (1) and means (43) for deriving from said reflected radiation a central aperture signal (CA), a focus error signal (FES_{RVO}) and a tracking error signal (TES), the apparatus comprising signal processing means (43) for generating an improved focus error signal (IFES_{RVO}) by subtracting from said focus error signal (FES_{RVO}) at least one signal consisting of a product of said tracking error signal (TES) or said central aperture signal (CA) and a scaling factor (γ), said scaling factor (γ) being adaptive based on said improved focus error signal (IFES_{RVO}).

2. Apparatus according to claim 1, wherein said improved focus error signal (IFES_{RVO}) is generated by subtracting first and second signals from said focus error signal (FES_{RVO}), said first signal (γ,TES) consisting of a product of said tracking error signal (TES) and a first adaptive scaling factor (γ₁) and said second signal (γ₂CA) consisting of a product of said central aperture signal (CA) and a second scaling factor (γ₂)

3. Apparatus according to claim 2, wherein said the first and second scaling factors (γ₁, γ₂) are different from each other.

4. Apparatus according to claim 2 or claim 3, wherein the scaling factors (γ₁, γ₂) derived and updated by minimising a cost function (J(γ₁, γ₂)) which is able to imply the radial to focus crosstalk components remaining in said improved focus error signal (IFES_{RVO}).

5. Apparatus according to claim 4, wherein said cost function is defined as the sum of cross-correlation between a pre-processed said improved focus error signal ( I̅F̅E̅S̅_{RVO}) and the tracking error signal (TES) and that between a pre-processed said improved focus error signal ( I̅F̅E̅S̅_{RVO}) and the central aperture signal (CA).

6. Apparatus according to claim 5, wherein said first scaling factor (γ₁) is directly proportional to an integral of the product of said pre-processed improved focus error signal ( I̅F̅E̅S̅_{RVO}) and the tracking error signal (TES) and said second scaling factor (γ₂) is directly proportional to an integral of the product of said pre-processed improved focus error signal ( I̅F̅E̅S̅_{RVO}) and said central aperture signal (CA).

7. Apparatus according to claim 6, wherein said integrals are multiplied by a constant which controls the stability and speed of adaption of said scaling factors (γ₁, γ₂).

8. Apparatus according to claim 4, wherein said cost function is defined as the sum of cross-correlation between said improved focus error signal (IFES_{RVO}) and a pre-processed said tracking error signal ( T̅E̅S̅) and that between said improved focus error signal (IFES_{RVO}) and a twice pre-processed said central aperture signal ( C̅A̅).

9. Apparatus according to claim 5, wherein said first scaling factor (γ₁) is directly proportional to an integral of the product of said improved focus error signal (IFES_{RVO}) and said pre-processed said tracking error signal ( T̅E̅S̅) and said second scaling factor (γ₂) is directly proportional to an integral of the product of said improved focus error signal (IFES_{RVO}) and said twice pre-processed said central aperture signal ( C̅A̅).

10. An optical storage system comprising an optical scanning spot (11) for scanning an optical information carrier (1), an optical system (25, 26) for receiving radiation reflected from said optical information carrier (1) and signal processing means (43) for deriving from said reflected radiation a central aperture signal (CA), a focus error signal (FES_{RVO}) and a tracking error signal (TES), generating an improved focus error signal (IFES_{RVO}) by subtracting from said focus error signal (FES_{RVO}) at least one signal consisting of a product of said tracking error signal (TES) or said central aperture signal (CA) and a scaling factor (γ₁, γ₂), and updating said scaling factor (γ₁, γ₂) adaptively based on said improved focus error signal (IFES_{RVO}).

11. An optical storage system according to claim 8, wherein said optical system comprises an astigmatic lens (25) and a four-quadrant photo detector (26).

12. A method for compensating for radial to focus crosstalk in an optical storage system comprising an optical scanning spot (11) for scanning an optical information carrier (1), an optical system (25, 26) for receiving radiation reflected from said optical information carrier (1) and means (43) for deriving from said reflected radiation a central aperture signal (CA), a focus error signal (FES_{RVO}) and a tracking error signal (TES), the method comprising providing signal processing means (43) for generating an improved focus error signal (IFES_{RVO}) by subtracting from said focus error signal (FES_{RVO}) at least one signal consisting of a product of said tracking error signal (TES) or said central aperture signal (CA) and a scaling factor (γ₁, γ₂), and updating said scaling factor (γ₁, γ₂) adaptively based on said improved focus error signal (IFES_{RVO}).
